(19) United States
(12) Patent Application Publication
(10) Pub. No.: US 2005/0189790 A1
(43) Pub. Date: Sep. 1, 2005

(54) Automotive side frame and upper structure and method of manufacture

(76) Inventors: Adrian B. Chernoff, Troy, MI (US); Richard M. Kleber, Clarkston, MI (US); Mark G. Konopnicki, Rochester, MI (US); Stephen R. Koshorek, Royal Oak, MI (US); Jacob Lyjak, Washington Township, MI (US); Chongmin Kim, Bloomfield Twp, MI (US)

Correspondence Address: KATHRYN A MARRA;General Motors Corporation, Legal Staff - Mail Code 482-C23-B21, P.O. Box 300, Detroit, MI, 48265-3000, US

(21) Appl. No.: 11/067,607

(22) Filed: Feb. 25, 2005

Related U.S. Application Data
(60) Provisional application No. 60/548,358, filed on Feb. 27, 2004.

(51) Int. Cl. B62D 25/02

(52) U.S. Cl. 296/193.05

(57) ABSTRACT

A two-piece side frame comprising a one-piece inner panel and a one-piece outer panel that are operatively connected to one another and extending substantially longitudinally at least the entire length of the vehicle passenger compartment. Consolidations of upper body structures such as front cowl beam, front structure, front tie bar assembly, roof and rear package shelf, and the rear structure of a vehicle using fluid forming processes are provided. A method of producing the two-piece side frame as well as a B pillar and cowl beam by utilizing fluid forming techniques is provided.

### CROSS REFERENCE TO RELATED APPLICATIONS

This Application claims the benefit of U.S. Provisional Application No. 60/548,358 filed Feb. 27, 2004, which is hereby incorporated by reference in its entirety.

### TECHNICAL FIELD

This invention relates to a two-piece side frame comprising a one-piece inner panel and a one-piece outer panel, operatively connected to one another, and extending substantially longitudinally at least the entire length of the vehicle passenger compartment. Consolidations of upper body structures such as front cowl beam, front structure, front tie bar assembly, roof and rear package shelf, and the rear structure of a vehicle using fluid forming processes are provided.

### BACKGROUND OF THE INVENTION

A typical prior art vehicle body requires a plurality of components to form and define the upper body components of the vehicle. The upper body components are typically formed by welding together multiple steel stampings into a single assembly. For instance, a vehicle side frame may include a rocker beam, front hinge pillar, windshield pillar, longitudinal roof beam, rear window pillar, rear wheelhouse pillar and center door pillar. Typically each of these areas would be a separate panel. Each panel would have its respective forming tool and corresponding fixtures for assembly.

### SUMMARY OF THE INVENTION

By utilizing fluid forming techniques such as quick plastic forming (QPF), superplastic forming (SPF) and sheet hydroforming processes, vehicle components may be consolidated, thus simplifying processing and assembly. Structures may take on more complex forms, utilizing materials that may enable potential improvements in fuel economy. Vehicle components formed using quick plastic forming (QPF) processing may be comprised of metallic and other materials that meet styling, functionality and performance requirements.

In one aspect of the invention, a vehicle structure is provided that includes a two-piece side frame comprising a one-piece inner panel and a one-piece outer panel. The outer panel is operatively connected to the inner panel. The two-piece side frame substantially extends longitudinally at least the entire length of the vehicle passenger compartment.

In another aspect of the invention, the one-piece inner panel and the one-piece outer panel at least partially define a rocker beam, front hinge pillar, windshield pillar, longitudinal roof beam, rear window pillar, rear wheelhouse pillar and center door pillar. The part consolidations reduce the number of forming tools and corresponding fixtures for assembly.

In another aspect of the invention, the one piece side frame inner panel is formed to at least partially define the front wheelhouse and rear wheel house.

In another aspect of the invention, part consolidations are achieved in forming one piece upper body components such as the front cowl beam, front structure, front tie bar assembly, roof and rear package shelf, and the rear structure.

In another aspect of the invention, a method of manufacturing the two piece side frame structure is provided. A fluid forming technique, such as QPF and SPF is employed to form the side frame one-piece inner panel and one-piece outer panel from a single sheet metal blank. The single sheet fluid-forming technique is preferably augmented by forming techniques such as plural sheet forming, patch reinforcement forming, tailor welded blank forming, multi-material forming, metallic foam forming and other variants.

The above features and advantages, and other features and advantages, of the present invention are readily apparent from the following detailed description of the best mode for carrying out the invention when taken in connection with the accompanying drawings.

### BRIEF DESCRIPTION OF THE DRAWINGS

FIG. 1 is a schematic exploded perspective view of a two-piece side frame;

FIG. 2 is schematic perspective view of the upper body structure of a vehicle;

FIG. 3 is a schematic perspective view of a center pillar or B pillar assembly;

FIG. 4 is a cross-sectional view of a B pillar upper and lower panel formable using QPF processes;

FIG. 5 is a cross-sectional view of the B pillar upper and lower panel in FIG. 4 after forming;

FIG. 6 is a schematic perspective view of a center pillar or B pillar with an external reinforcement added;

FIG. 7 is a cross-sectional view of three panels formable using QPF processes to manufacture a reinforced B pillar;

FIG. 8 is a cross-sectional view of the three panels in FIG. 7 after being formed into a reinforced B pillar;

FIG. 9 is a schematic perspective view of a vehicle cowl and windshield frame assembly;

FIG. 10 is a schematic perspective illustration of the vehicle cowl portion of FIG. 9;

FIG. 11 is an exploded cross-sectional view of an upper cowl portion and a lower cowl portion formable using QPF processes;

FIG. 12 is a cross-sectional illustration of another vehicle cowl formable using QPF processes;

FIG. 13 is a cross-sectional illustration of yet another vehicle cowl formable using QPF processes, prior to formation; and

FIG. 14 is a cross-sectional illustration of yet another vehicle cowl formable using QPF processes, after formation.

### DESCRIPTION OF THE PREFERRED EMBODIMENTS

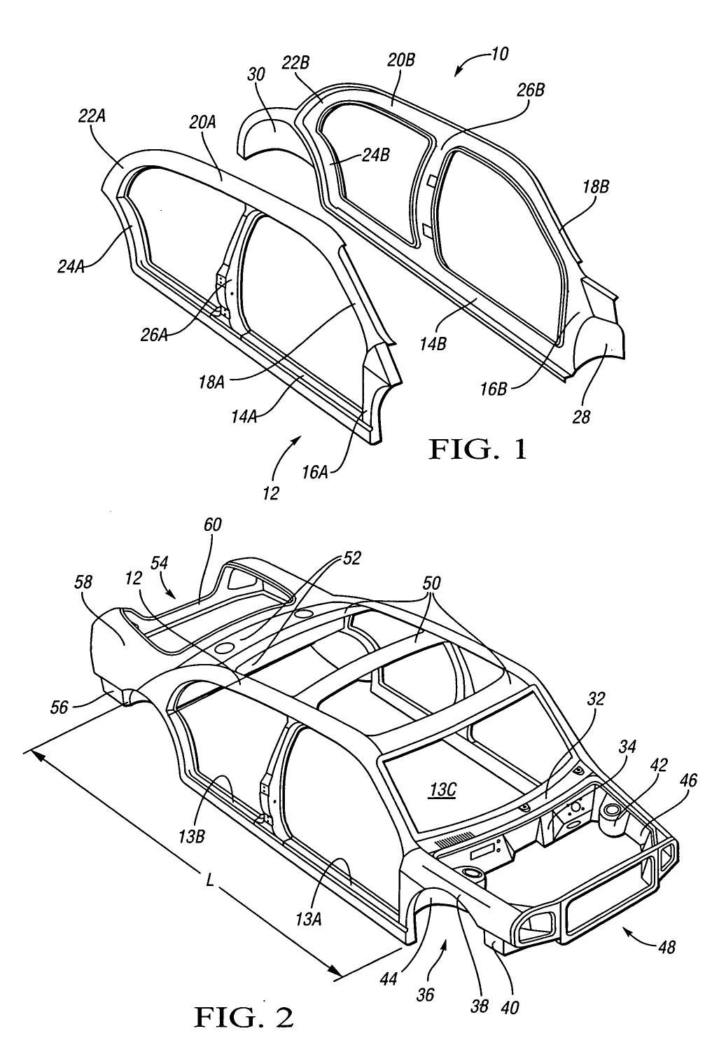

Referring to the drawings, wherein like reference numbers refer to like components, FIG. 1 is an illustration of a two piece vehicle side frame. The two piece side frame is comprised of a one-piece inner panel 10 and a one-piece outer panel 12. The outer panel 12 is operatively connected to the inner panel 10. The two-piece side frame defines a front door opening 13A and a rear door opening 13B within the length L of the vehicle passenger compartment 13C. The one piece outer panel 12 at least partially defines at least one rocker beam 14A, front hinge pillar 16A, windshield pillar 18A, longitudinal roof beam 20A, rear window pillar 22A, rear wheelhouse pillar 24A and center door pillar or B pillar 26A. The one piece inner panel 10 at least partially defines at least one rocker beam 14B, front hinge pillar 16B, windshield pillar 18B, longitudinal roof beam 20B, rear window pillar 22B, rear wheelhouse pillar 24B and center door or B pillar 26B. The one piece inner panel 10 may also at least partially define the front wheelhouse portion 28 and rear wheelhouse portion 30 of the vehicle.

FIG. 2 is an illustration of a vehicle upper body structure. The use of quick plastic forming (QPF), superplastic forming (SPF) technologies and their variants permits reduction of the number of components required in the upper body structure. Consolidation of multi-part structures into one-piece structures reduces the number of forming tools and eliminates the need for most of the weld fixtures. Referring to FIG. 2, a one-piece front cowl beam 32 is shown. The one-piece front cowl beam is attached to the one-piece side frame inner panel 10 and one-piece side frame outer panel 12. Additionally, the front cowl beam can be consolidated together with the front of the dash panel 34 into a singular structure, with the use of QPF processes.

A one-piece front structure 36 is shown in FIG. 2. The one-piece front structure 36 is attached to the one-piece side frame inner panel 10 and one-piece side frame outer panel 12. The one-piece front structure 36 at least partially defines at least one motor compartment rail 38, front fascia attachment bracket 40, suspension shock tower 42 and front wheelhouse liners 44 and 46. A one-piece front tie bar assembly 48 is attached to the one-piece front structure. Typically the front tie bar assembly 48 would be composed of a multitude of components welded into an assembly. Utilization of QPF and SPF processes enables consolidation of multiple components into a one-piece structure.

A one-piece roof structure 50 and rear package shelf 52 is attached to the one-piece side frame inner panel 10 and one-piece side frame outer panel 12.

Also shown in FIG. 2 is a one-piece rear structure 54 attached to the one-piece side frame inner panel 10 and one-piece side frame outer panel 12. The one-piece rear structure 54 at least partially defines at least one rear fascia bracket 56, rear quarter panel 58 and rear tie bar 60.

Those skilled in the art will recognize a variety of materials that may be employed to form the one-piece side frame inner panel 10 and one-piece side frame outer panel 12, including various metals and plastics. Those skilled in the art will also recognize a variety of forming techniques that may be employed within the scope of the claimed invention, such as, but not limited to, stamping, injection molding, etc. However, a fluid forming technique such as quick plastic forming, superplastic forming, or sheet hydroforming is preferably employed to form the one-piece side frame inner panel 10 and one-piece side frame outer panel 12. A number of these techniques are described herein.

Single Sheet QPF

Quick plastic forming (QPF) is described in U.S. Pat. No. 6,253,588, issued Jul. 3, 2001 to Rashid, et al, commonly assigned to General Motors, which is hereby incorporated by reference in its entirety. For quick plastic forming, a preferred alloy is Aluminum Alloy 5083 having a typical composition, by weight, of about 4% to 5% magnesium, 0.3 to 1% manganese, a maximum of 0.25% chromium, about 0.1% copper, up to about 0.3% iron, up to about 0.2% silicon, and the balance substantially all aluminum. Generally, the alloy is first hot and then cold rolled to a thickness from about one to about four millimeters.

In the AA5083 alloys, the microstructure is characterized by a principal phase of a solid solution of magnesium in aluminum with well-distributed, finely dispersed particles of intermetallic compounds containing the minor alloying constituents, such as Al₆Mn.

Using QPF, large AA5083-type aluminum-magnesium alloy sheet stock may be formed into a complex three-dimensional shape with high elongation regions, like a super-plastic formed (SPF) (discussed below) part, at surprisingly higher production rates than those achieved by SPF practices. The magnesium-containing, aluminum sheet is heated to a forming temperature in the range of about 400° C. to 510° C. (750° F. to 950° F.). The forming may often be conducted at a temperature of 460° C. or lower. The heated sheet is stretched against a forming tool and into conformance with the forming surface of the tool by air or gas pressure against the back surface of the sheet. The fluid pressure is preferably increased continuously or stepwise from 0 psi gage at initial pressurization to a final pressure of about 250 to 500 psi (gage pressure, i.e., above ambient pressure) or higher. During the first several seconds up to about, e.g., one minute of increasing pressure application, the sheet accommodates itself on the tool surface. After this initial period of pressurization to initiate stretching of the sheet, the pressure can then be increased at an even faster rate. Depending upon the size and complexity of the panel to be formed, such forming can normally be completed in a period of about two to twelve minutes, considerably faster than realized in superplastic forming. Thus, by working a suitably fine grained, aluminum alloy sheet at significantly lower temperatures and continuously increased, higher gas pressures than typical SPF practices, significantly faster and more practical forming times are achieved for the parts described herein and their equivalents. This particular QPF process described in U.S. Pat. No. 6,523,588 may be referred to as “single sheet” QPF.

Superplastic Forming

Where time is not of the essence, the side frame one-piece inner panel 10 and one-piece outer panel 12 may also be formed by superplastic forming (SPF), as described in U.S. Pat. No. 5,974,847, issued Nov. 2, 1999 to Saunders, et al and commonly assigned to General Motors, which is hereby incorporated by reference in its entirety. When certain alloy compositions of steel or aluminum are suitably processed (such as with a very fine grain microstructure), they exhibit superplastic behavior at certain elevated temperatures. When deformed at these temperatures, the ductility (or elongation before yield or failure) of these materials exceeds several hundred percent. Such high levels of ductility can enable fabrication of very complex structures in a single sheet of material.

Materials

In addition to various steels and aluminum alloys, other structural materials such as zinc, brass, magnesium, titanium and their alloys have also been reported to exhibit superplastic behavior. These materials and other metal matrix composites could also be used to make the side frame one-piece inner panel 10 and one-piece outer panel 12, if desired.

In an example of superplastic forming, a blank, i.e., a sheet, is tightly clamped at its edges between complementary surfaces of opposing die members. At least one of the die members has a cavity with a forming surface opposite one face of the sheet. The other die opposite the other face of the sheet forms a pressure chamber with the sheet as one wall to contain the working gas for the forming step. The dies and the sheet are heated to a suitable SPF condition for the alloy. For SPF aluminum alloys, this temperature is typically in the range of 400° C. to 550° C. Electric resistance heating elements are located in press platens or sometimes embedded in ceramic or metal pressure plates located between the die members and the platens. A suitable pressurized gas such as argon or air is gradually introduced into the die chamber on one side of the sheet, and the hot, relatively ductile sheet is stretched at a suitable rate until it is permanently reshaped against the forming surface of the opposite die. The rate of pressurization is controlled so the strain rates induced in the sheet being deformed are consistent with the required elongation for part forming. Suitable strain rates are usually 0.0001 to 0.01 s−1. During the deformation of the sheet, gas is vented from the forming die chamber.

The '847 patent provides a method of stretch forming a ductile metal sheet into a complex shape involving significant deformation without excessive thinning of the sheet material and without tearing it. The method is particularly applicable to the stretch forming of superplastic alloys heated to a superplastic forming temperature. In the method, additional material from the initially flat sheet blank is pulled or drawn into the forming cavity for stretch forming. The additional material significantly reduces thinning and tearing in the formed part.

The method contributes to thickness uniformity in an SPF stretch-formed component by utilizing controlled draw-in of sheet metal to the forming chamber prior to application of gas pressure. In an illustrative practice, a preform, similar to a stationary male punch, is placed on the forming press platen opposite the die cavity. An aluminum blank, for example, is placed over the insert and heated to a suitable SPF temperature for the alloy. The die is then moved toward its closed position against the platen. In its closing motion, the die engages the edges of the aluminum sheet. The heated metal is pulled over and around the insert, and draw-in of blank material thus occurs. This results in a greater amount of metal in the die cavity prior to SPF blow forming. The quantity of additional metal can be managed by design of the size, shape and location of the preform on the platen or complementary die member. But the additional metal in the die cavity reduces the amount of strain required and, hence, the amount of thinning to form a desired geometry compared to conventional SPF.

Thus, by the judicious use of a suitable space-occupying metal preform on a die or platen member opposite the forming die, additional metal is easily drawn into the cavity during die closure without significantly increasing the complexity of the tooling. Care is taken in the design of the preform to avoid excessive wrinkling of the drawn-in metal and to maintain a tight gas seal at the periphery of the sheet upon full die closure. The uniformity in thickness of the stretch-formed part is improved. Mass of the formed part can be reduced because the designer does not need to resort to thicker blanks to assure part quality. And, except for the simple preform, there is no increase in the complexity of the SPF tooling.

Other Techniques

Those skilled in the art will recognize various adjunct techniques to augment the above fluid forming techniques. Such adjuncts include plural sheet forming, multi-layer patch forming, multi-material forming and tailor welded blank forming, which allow for simultaneous formation of members in the same tool. Some applicable processes are briefly summarized below.

Two Sheet, Opposite Direction Formation

The one-piece side frame inner panel 10 and one-piece side frame outer panel 12 may be formed using a plural sheet forming process in which the inner panel 10 and outer panel 12 are simultaneously formed to the respective shapes of opposing dies by directing pressurized air or gas between the blanks, forcing the blanks in opposite directions toward the opposing dies. Such a process is described in U.S. Pat. No. 6,675,621, issued Jan. 13, 2004 to Kleber and commonly assigned to General Motors, which is hereby incorporated by reference in its entirety. A forming tool (not shown) with a movable upper tool die and movable lower tool die is employed. By forming the panels simultaneously in a pair of dies, the output of the superplastic forming equipment, including the dies, is multiplied for improved efficiency. Two superplastic formable sheet metal blanks are inserted between the upper and lower forming dies (not shown). The sheets are stacked closely together to define a common interface therebetween. The sheet metal blanks may be welded together with a perimeter weld with the exception of a small length to allow for pressurization between the blanks. The upper and lower sheet metal blanks may be welded or otherwise joined either after forming or prior to forming. The forming dies are heated so that the temperature of the pair of sheet metal blanks reaches a temperature for superplastic forming. As the upper tool die is closed, it deforms the sheet metal blanks. The lowest sealing feature of the upper tool die urges the blanks against the lower tool die and a seal is established at their common interface that partially encompasses an internal chamber between the sheet metal blanks. The sealing creates separate pressurization chambers inside the forming tool dies; a perimeter pressurization chamber outside the lowest sealing feature and an internal pressurization chamber inside the lowest sealing feature, allowing for different pressurization inside and outside the sealing feature.

Pressurized air or gas is introduced into both internal chambers to increase their volumes to simultaneously effect the stretching of the sheet metal blanks into the upper and lower profiling dies and to thereby plastically form the sheet metal blanks into the profile of the forming dies. For instance, a pressurization wedge (not shown) may be moved from one side of the overlying sheets to a fluid sealing or stopper position between the sheets and in which a forward edge portion of the upper sheets is displaced upwardly to define a gas entry way between the two blanks and to complete the pressure sealing of the air space between the blanks, as described in the '621 patent. Pressurized air or gas may then be entered through at least one fluid conducting passage (not shown) formed through the wedge and within the bounds of the pressure sealing of the two heated sheets that effects the simultaneous displacement of the sheets from one another onto the forming dies.

A process for simultaneously forming two superplastic formable parts to upper and lower die halves is described in U.S. Pat. No. 6,694,790, issued Feb. 24, 2004 to Ryntz et al. and commonly assigned to General Motors, which is hereby incorporated by reference in its entirety. The '790 patent utilizes a mid-plate that supports and separates the upper and lower sheet metal blanks between forming dies. An inner chamber is formed by the mid-plate. Pressurized gas is introduced into the inner chamber, thereby expanding the sheets away from one another onto structure of the dies to simultaneously form discreet parts reflective of the upper and lower forming surfaces. This method utilizing a mid-plate may be used with a die having equivalent upper and lower surfaces, thus providing duplicate parts with each pressurization or the upper and lower dies may have differing forming surfaces, thus forming two different parts with each pressurization.

Thus, the two sheet, opposite direction processes disclosed in the '621 patent and in the '790 patent allow for efficient superplastic or quick plastic forming of automotive components.

Tailor Welded Blanks

A vehicle structure or accessory may be formed as a multi-thickness, single membrane under a fluid forming process such as hydroforming, SPF, or QPF. Under this process, one or both upper and lower sheet metal blanks may be formed by the tailor welded blank process described in U.S. Pat. No. 6,825,442, issued Nov. 30, 2004 to Schroth et al. and commonly assigned to General Motors Corporation, which is hereby incorporated by reference in its entirety. The tailor welded blank process described in the '442 patent allows tailor welded blanks having sheet elements with different values of a physical characteristic, such as sheet thickness, to be processed successfully into components. Many alloy systems including, but not limited to, steel, aluminum, magnesium and titanium materials may be processed to form the tailor welded blank. Hydroforming, SPF and QPF may be used to form the tailor welded blank. The tailor welded blank process utilizes a blank that has variations in the thickness of sheet elements that is amenable to forming in a fluid forming process to large relative strains and consequently into complex shapes. The sheet elements that form the tailor welded blank deform at nearly the same rate even though they have different values of a physical characteristic, such as different thicknesses or different material strength values.

Patch Reinforcement Process

The patch reinforcement process described in U.S. Pat. No. 6,550,124, issued Apr. 22, 2003 to Krajewski, et al. and commonly assigned to General Motors, which is hereby incorporated by reference in its entirety, may be utilized in the formation of the side frame one-piece inner panel 10 and one-piece outer panel 12. U.S. Pat. No. 6,550,124 provides a method of locating and temporarily bonding a sheet metal reinforcing piece or patch to another sheet metal blank prior to an SPF operation (including the QPF operation of U.S. Pat. No. 6,253,588) on the two sheet layers. The smaller piece or patch is positioned and bonded on the blank sheet to undergo the same deformation as the adjacent blank sheet region that is intended to be reinforced or otherwise benefited by the patch. Generally, the secondary piece or patch is removed after the forming operation for later permanent attachment (i.e., by welding or other means) to the formed blank or similar piece. Water glass, i.e., a water soluble glassy substance comprising sodium silicate, is used to attach the reinforcing piece of metal to the SPF blank prior to fluid forming. The water glass is stable and non-reactive at elevated temperatures, allowing it to withstand the superplastic forming environment without degradation of the metal sheets, and to release the sheets from one another after forming. Such reinforcing patches may be employed to provide strengthening formations to a panel.

U.S. Pat. No. 6,547,895, issued Apr. 15, 2003 to Bradley et al. and commonly assigned to General Motors, which is hereby incorporated by reference in its entirety, discloses a method of forming multi-layer patches by a specific fluid forming process for patching or reinforcing a main sheet. As disclosed in the '895 patent, multi-layer patches may be formed simultaneously by an SPF or QPF process such that the separate patch layers closely fit the adjoining portion of the main layer. The reinforcing patches may be spot welded or otherwise joined to the main sheet but preferably they are formed without becoming diffusion bonded during the forming process itself. Final joining of the sheets, if required, is accomplished after the forming process. Utilization of the multi-formed patch process of the '895 patent facilitates a thicker, SPF or QPF formed part than with single sheet processing, with minimal defects and often in a shorter processing time.

Multi-Material Components

If desired, a vehicle structure such as the side frame one-piece inner panel 10 and one-piece outer panel 12, may be formed of differing materials using a QPF forming process. For instance, the magnesium/aluminum bonded components may be formed by the method described in U.S. Pat. No. 6,450,396, issued Sep. 17, 2002 to Krajewski and commonly assigned to General Motors. In this instance, the panel is formed from a first substrate and a second substrate. The first substrate includes at least 90 weight percent aluminum in the first set of additives, magnesium being the dominant constituent in the additives. The second substrate includes at least 85 weight percent magnesium and a second set of additives, aluminum being the dominant constituent of the second set of additives. The first and second substrates are heated to an elevated temperature as described in the '396 patent. Pressure is applied to the substrates at least at one point of contact to bond the substrates to one another. An upper sheet metal blank may be the first aluminum dominant substrate and the lower sheet metal blank may be the second magnesium dominant substrate. By undergoing the bonding process described in the '396 patent, the two portions may be diffusion bonded to one another at adjacent areas by undergoing the process of the '396 patent.

Multi-Material Tailor Welded Blank

A body structure such as the side frame one-piece inner panel 10 and one-piece outer panel 12 may be formed from sheet elements of two different materials that are tailor welded together at respective edges thereof and then subjected to a QPF, or SPF or warm forming process. Accordingly, different materials are tailor welded to form a single blank, and are then formed together in the same die under a fluid forming process. A continuous, complex shape is obtained. Different portions of the single sheet have different material properties (such as strength) dependent upon which of the originally separate (but tailor welded together) multiple materials form the respective portions.

Two separate pieces of sheet material, a first sheet (preferably aluminum (AA5083)) and a second sheet (preferably magnesium (AZ31B)) are welded to one another to form a single blank. The sheets may have the same or different thicknesses, depending on strength and stiffness requirements of corresponding areas in the formed part. Preferably, friction stir welding is used to join the sheets. Friction stir welding enables a reliable weld region, without forming the brittle intermetallic phase associated with a molten, mixed and resolidified area of mixed metals at the weld region, typically encountered with other welding processes. The blank may be subjected to QPF, SPF or other elevated temperature forming processes to form, for example, an automotive body or frame structure. The weld region retains superplastic properties.

Two blanks of differing materials, for instance an aluminum alloy blank and a magnesium alloy blank may also be welded at a periphery (preferably by friction stir welding) and then subjected to a QPF, SPF or other fluid forming, elevated temperature process involving pressurization between the blanks.

QPF and SPF Forming of Multi-Sheet Metallic Structure Using a Stack of Blanks Pre-Joined by Friction Stir Welding

A vehicle component such as the side frame one-piece inner panel 10 and one-piece outer panel 12 may be formed from multiple sheets. The sheets may begin as flat, stacked sheets that are friction stir welded to one another. Friction stir welding is a solid state joining process that produces ultra fine microstructure in titanium and aluminum alloys upon in-process dynamic recrystallization or subsequent annealing treatment. Those skilled in the art will readily understand friction stir welding. The friction stir welding technique may be applied to aluminum alloys, magnesium alloys and titanium alloys. Portions of a stack of sheet blanks are friction stir welded to one another at selected areas, prior to SPF or QPF forming of the sheets. High temperature gas pressure forming produces a multi-sheet structure with complex internal structures. The resulting multi-layer structure exhibits great stiffness and strength.

Metallic Foam Forming Process

The side frame one-piece inner panel 10 and one-piece outer panel 12 may be formed by a method of metallic sandwiched foam composite forming as described in A Method of Metallic Sandwiched Foam Composite Forming, U.S. patent application Ser. No. 10/738,345, commonly assigned by General Motors Corporation, filed Dec. 17, 2003 by Morales et al., and hereby incorporated by reference in its entirety, or by a method for producing in situ metallic foam components, as described in Method for Producing In Situ Metallic Foam Components, U.S. patent application Ser. No. 10/738,884, commonly assigned by General Motors Corporation, filed Dec. 17, 2003 by Morales et al., and hereby incorporated by reference in its entirety. The sandwiched foam composite forming method involves subjecting a planar metal sheet to an SPF or QPF process. Either during or after the SPF or QPF processing of the sheet metal, a composite structure is formed by coupling a metal foam layer to the formed metallic sheet. As described in application Ser. No. 10/738,345, the coupling of the metallic foam to the QPF or SPF metal sheet may be accomplished by using adhesives or brazing materials which are deposited between the deformed metallic sheet and the foam substrate. In addition, the QPF or SPF formation of the sheet metal may include forming a pair of locking interfaced surfaces which can be elastically deformed to engage a pair of sculpted surfaces on the foam material.

The foam substrate may be coupled to the QPF or SPF sheet during the QPF or SPF forming process. In that case, the foam substrate is sculpted prior to forming and is inserted into a QPF die with the unformed sheet metal. QPF or SPF may then be applied to deform the metal sheet about the sculpted foam. Alternatively, the formation of the foam substrate may occur during the SPF or QPF processing of the sheet metal. When the composite structure is formed, the foam substrate can then be adhered to the sheet metal by fusion or with the use of braze material disposed in the construction. Alternatively, the coupling may occur by mechanical interaction or fusion coupling of the foam to the sheet metal. Finally, the foam substrate may be bonded to the sheet metal prior to the QPF or SPF processes. As described in application Ser. No. 10/738,345, SPF and QPF may be used to form foam, a one sided sandwich foam composite (i.e., sheet metal on only one side of the foam) or a two sided sandwich foam composite (i.e., foam having a sheet metal on either side). The foam, the one sided or the two sided sandwich foam composite, is then processed by QPF or SPF within a die or forming tool such that the foam or sandwich panel conforms to the shape of the die or tool forming surface.

As described in application Ser. No. 10/738,884, a method for producing in situ metallic foam components may be used in forming the side frame one-piece inner panel 10 and one-piece outer panel 12. Foam precursor materials formed from a mixture of metal powders (elementary metal powders, alloy powder or a metal powder blend) and a blowing agent (for example, TiH₂) is compacted to densely formed, semi-finished, precursor element). The composite of sheet metal and foam precursor is then subjected to an SPF or QPF forming technique which both forms the sheet metal and causes forming of the metal foam precursor such that it forms to a desired shape pursuant to the adjacent die formation. Alternatively, metal sheets may sandwich an intermediate metal foam precursor layer. The sandwich structure is then subjected to a QPF or SPF forming process within the die to form a deformed sheet metal sandwich. The deformed sheet metal sandwich is then heated to a temperature greater than the formation temperature so as to form the metal foam precursor. Accordingly, a single forming operation provides complex composite structures of low weight metallic composites. The composites provide excellent energy absorption properties, and dent resistance. A metal foam precursor may be adhered or fused to an underside of a sheet metal blank to form a reinforcing patch thereon. Alternatively, metallic foam precursor may be used between an upper and lower sheet metal blank prior to QPF or SPF forming thereof.

A variety of upper body vehicle components may be made utilizing fluid forming techniques including QPF. A B pillar and a cowl beam are discussed herein as well as applicable forming techniques.

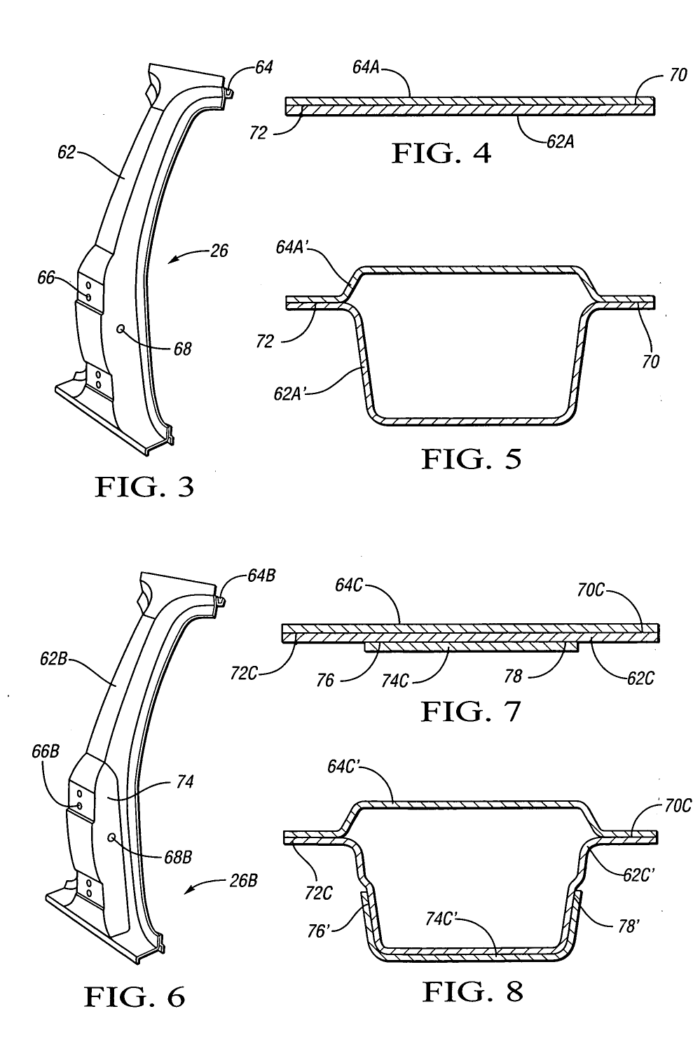

B-Pillar FIGS. 3-8

By utilizing QPF techniques and its variants using sheet metal panels as described above, a strong, low mass B pillar can be formed. FIG. 3 illustrates a B pillar 26 separate from the vehicle side frame structure. The B pillar 26 is characterized by an outer B pillar panel 62 and an inner B panel 64. The B pillar is shaped with cavities 66 to support and attach the rear door hinges and doors. Additionally, the B pillar serves to support and attach the front door latch hardware 68. Other functions of the B pillar include providing a vertical load path in body side door openings for multiple vehicle loading, as well as supporting and attaching shoulder harnesses and seat belt components. The B pillar also enhances structural rigidity.

FIG. 4 shows a cross section of the outer B pillar panel 62 and inner B panel 64 prior to formation in a single QPF pressurization in a plural-sheet forming tool. In the preform stage, individual components 62A and 64A were joined as flat sheets and sealed by a perimeter weld that intersects the cross sectional view in two locations 70 and 72.

Referring to FIG. 5, a cross sectional view of the outer B pillar panel 62 and inner B panel 64 after formation is shown. After placement in a plural-sheet forming tool, pressurization is applied between the B pillar components 62A′ and 64A′. The pressurization forces the outer B pillar portion 62A′ against one half of the plural-sheet forming tool and the inner B pillar portion 64A′ against the other half of the tool, as illustrated in the post forming cross section of FIG. 5. The perimeter weld intersects the cross sectional view in two locations 70 and 72.

Referring to FIG. 6, the B pillar 26B is shown with an external reinforcement 74 added to the outer B pillar panel 62B and inner B panel 64B. The reinforcement 74 serves to increase stiffness and strength at the rear door hinge attachment detail 66B and the front door latch attachment 68B.

In FIG. 7, the reinforced B pillar is shown in cross section prior to formation in a plural sheet QPF process. In the preform, components are layered and welded. The external reinforcement 74C and the outer B pillar portion 62C are then placed in a stack while in a flat unformed condition. A non-continuous perimeter weld that intersects the cross section at two locations 76 and 78 joins the components. The inner B pillar portion 64C is added to the stack and sealed by a perimeter weld that intersects the cross sectional view in two locations 70C and 72C.

Referring to FIG. 8, the reinforced B pillar is shown in cross section after formation in a plural sheet QPF process. After placement in a plural-sheet forming tool, pressurization is applied between the B pillar components 62C′ and 64C′. The pressurization forces the outer B pillar portion 62C′ and the external reinforcement 74C′ against one half of the plural-sheet forming tool and the inner B pillar portion 64C′ against the other half of the tool, resulting in the complex shape shown in FIG. 8. The perimeter welds 76′, 78′, 70C and 72C are shown. Use of QPF processes and its variants enables the production of a multi-layer structure with great stiffness and strength.

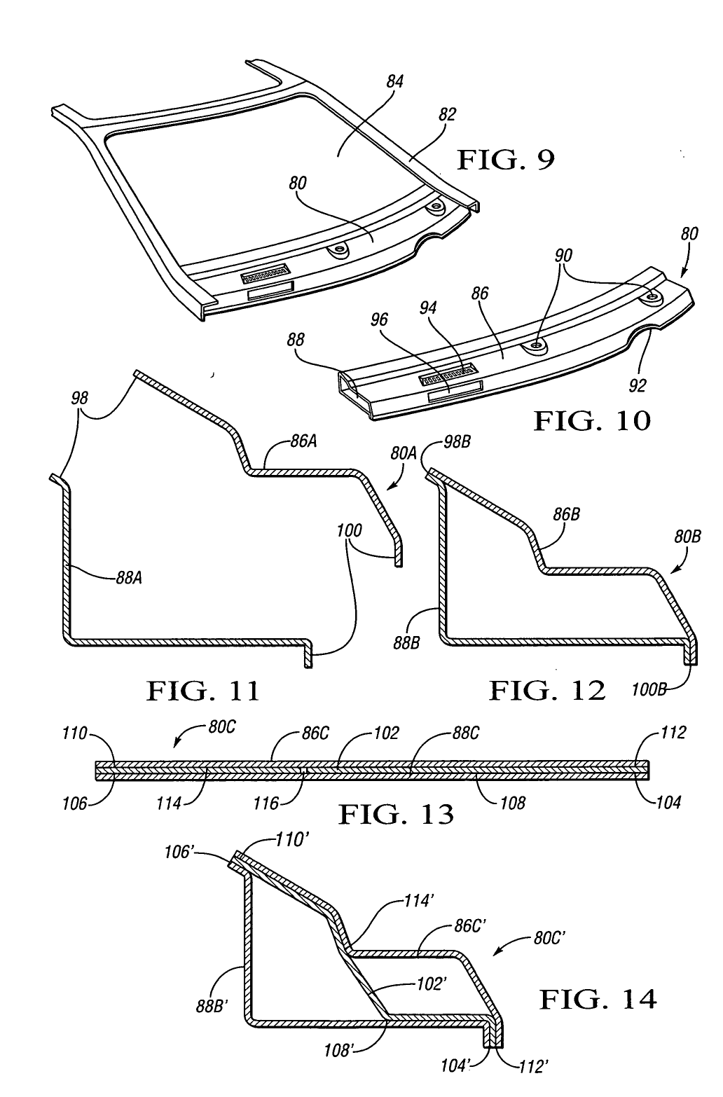

Cowl Beam FIGS. 9-14

A variety of QPF forming technologies, as discussed above, may be applied to form a cowl accurately and reliably provide the required shaped complexity.

Referring to FIG. 9, a cowl beam 80, also referred to herein as a cowl, is located at the base of a windshield frame 82 of a typical passenger vehicle. The cowl 80 acts as a structural frame member for the vehicle. Cowl 80 also serves as an attachment surface for a windshield 84. The cowl also serves as an attachment mechanism for a windshield wiper motor linkage and arms (not shown).

In FIG. 10, a view of the cowl beam 80 separate from the vehicle structure is shown. The cowl beam is a closed section with an upper portion 86 and a lower portion 88. Referring to FIG. 10, windshield wiper arm attachment mounts 90 are shown formed in the cowl 80. Additionally, the cowl 80 is formed with a wiper motor recess 92 configured to receive and serve as an attachment for a windshield wiper motor and/or windshield wiper motor linkage. The cowl 80 is further formed with an air intake opening 94 creating a flow chamber that permits ambient air to be directed to the vehicle heating, venting and air conditioning system (HVAC). An HVAC component attachment opening 96 is also formed in the cowl 80, enabling HVAC components to be attached to the cowl 80. The functions of the cowl include providing a transverse load path for multiple vehicle loading conditions.

As shown in FIGS. 9 and 10 and discussed with respect thereto, the cowl 80 is formed with a complex shape in order to provide the functions described above. Referring to FIG. 11, the upper cowl portion 86A and lower cowl portion 88A may be formed individually in different portions of the same forming tool or as separate sheets in a plural-sheet forming tool and thereafter assembled and joined as a cowl beam 80A. After forming, the portions are joined by welding joints 98 and 100 or other fastening means to form the completed cowl beam structure.

FIG. 12 illustrates a cowl beam 80B that was formed in a single QPF pressurization in a plural-sheet forming tool. The individual components 86B and 88B were joined as flat sheets and sealed by a perimeter weld that intersects the cross sectional view in two locations, 98B and 100B. After placement in a plural-sheet forming tool, pressurization is applied between the cowl beam components 86B and 88B. The pressurization forces the upper portion of the cowl beam against one half of the plural-sheet forming tool and the lower portion of the cowl beam is forced against the other half of the tool.

Referring to FIG. 13, the cowl beam 80C may be formed from multiple sheets including the upper cowl portion 86C, the lower cowl portion 88C and an intermediate cowl portion 102. FIG. 13 illustrates the sheets in cross section prior to QPF forming. The components are layered and welded with a single sided weld process such as laser welding or friction stir welding. The lower portion of the cowl beam 88C and the mid sheet 102 are placed in a stack while in a flat unformed condition. A perimeter weld that intersects the cross section at two locations 104 and 106 joins and seals the components. An additional weld intersects the cross section at a predetermined location 108 internal to the perimeter. The upper portion of the cowl beam 86C is added to the lower components 102 and 88C and is joined and sealed with a similar perimeter weld that intersects the cross section at two locations 110 and 112. An additional weld intersects the cross section at a predetermined location 114 internal to the perimeter. A least one opening 116 is provided through the mid sheet 102 to allow pressurized air to flow through the mid sheet 102 during pressurization of the completed perform 86C, 88C and 102.

FIG. 14 is a cross sectional view of the multiple sheet cowl beam 80C′ after QPF forming in a plural sheet forming tool. The pressurization forces the upper portion of the cowl beam 86C′ against one half of the plural-sheet forming tool and the lower portion of the cowl beam 88B′ against the other half of the tool. The forming of the mid sheet 102′ is controlled by the placement of the welds 114′ and 108′ in the cowl beam preform. Between weld 110′ and weld 114′, the pressurization urges the mid plate 102′ against the upper portion of the cowl beam 86C′ where they are intimately formed in a nesting configuration. Similarly, between weld 104′ and weld 108′ the pressurization urges the mid plate 102′ against the lower portion of the cowl beam 88B′ where they are intimately formed in a nesting configuration. Between weld 114′ and weld 108′ the mid sheet 102′ forms an internal structural membrane through the cowl beam. The nested portion of the mid plate would locally stiffen the cowl beam for component mounting loads and the internal structural membrane would stiffen the structure overall. The resulting multi-layer structure exhibits great stiffness and strength.

While the best modes for carrying out the invention have been described in detail through the above examples, those familiar with the art to which this invention relates will recognize various alternative designs and embodiments for practicing the invention within the scope of the appended claims. As such, one skilled in the art will recognize that the number, shape, composition and relative positions of the blanks, the sealing features and the pressurization chambers could be manipulated to create any number of different designs which are consistent with and within the scope of the invention.

1. A vehicle body comprising:
a two-piece side frame comprising a one-piece inner panel and a one-piece outer panel;
said outer panel operatively connected to said inner panel;
wherein said two-piece side frame defines a front door opening and a rear door opening.

2. The vehicle body of claim 1, wherein said two-piece side frame at least partially defines at least one rocker beam portion of the vehicle.

3. The vehicle body of claim 1, wherein said two-piece side frame at least partially defines at least one front hinge pillar portion of the vehicle.

4. The vehicle body of claim 1, wherein said two-piece side frame at least partially defines at least one windshield pillar portion of the vehicle.

5. The vehicle body of claim 1, wherein said two-piece side frame at least partially defines a longitudinal roof beam portion of the vehicle.

6. The vehicle body of claim 1, wherein said two-piece side frame at least partially defines at least one rear window pillar portion of the vehicle.

7. The vehicle body of claim 1, wherein said inner panel and said outer panel at least partially defines at least one rear wheelhouse pillar portion of the vehicle.

8. The vehicle body of claim 1, wherein said two-piece side frame at least partially defines at least one center door pillar portion of the vehicle.

9. The vehicle body of claim 1, wherein said two-piece side frame at least partially defines the front wheelhouse portion of the vehicle.

10. The vehicle body of claim 1, wherein said two-piece side frame at least partially defines the rear wheelhouse portion of the vehicle.

11. The vehicle body of claim 1, further comprising a one-piece front cowl beam operatively attached to said two-piece side frame.

12. The vehicle body of claim 1, further comprising a one-piece front structure attached to said two-piece side frame, wherein said one-piece front structure at least partially defines at least one motor compartment rail, front fascia attachment bracket, suspension shock tower and front wheelhouse liner portion of the vehicle.

13. The vehicle body of claim 12, further comprising a one-piece front tie bar assembly attached to said one-piece front structure.

14. The vehicle body of claim 1, further comprising a one-piece roof and rear package shelf attached to said two-piece side frame.

15. The vehicle body of claim 1, further comprising a one-piece rear structure attached to said two-piece side frame, wherein said one-piece rear structure at least partially defines at least one rear fascia bracket, rear quarter panel and rear tie bar portion of the vehicle.

16. A vehicle comprising:
a two-piece side frame comprising an inner panel and an outer panel;
said outer panel operatively connected to said inner panel;
wherein said two-piece side frame defines a front door opening and a rear door opening;
a one-piece front cowl beam attached to said two-piece side frame;
a one-piece front structure attached to said two-piece side frame;
a one-piece front tie bar assembly attached to said one-piece front structure,
a one-piece roof and rear package shelf attached to said two-piece side frame; and
a one-piece rear structure attached to said two-piece side frame.

17. A method for manufacturing a two-piece side frame for a vehicle, the method comprising:
forming an inner panel and an outer panel;
operatively connecting said inner panel to said outer panel to provide a two-piece side frame; and
wherein said two-piece side frame defines a front door opening and a rear door opening.

18. The method of claim 17, wherein the forming of said inner panel and said outer panel for said two-piece side frame includes simultaneously forming a pair of sheet metal blanks;
wherein said simultaneous forming of said blanks includes placing said blanks stacked closely together to define a common interface therebetween;
sufficiently heating said stacked blanks so that the temperature of said stacked blanks reaches a temperature for superplastic forming;
sealing said blanks to establish a sufficient seal at said common interface to partially define an internal chamber between said sheet metal blanks; and
supplying pressurized gas into said internal chamber to increase the volume of said internal chamber to simultaneously effect the stretching of said stacked blanks to thereby plastically deform said stacked blanks into said inner panel and said outer panel.

19. The method of claim 17, wherein said forming said inner panel and said outer panel includes forming said inner panel from a single sheet metal blank and separately forming said outer panel from another single sheet metal blank before connecting them together.

20. The method of claim 17, wherein said forming said inner panel and said outer panel is by single sheet quick plastic forming.
